(19) United States
(12) Patent Application Publication
(10) Pub. No.: US 2021/0031754 A1
(43) Pub. Date: Feb. 4, 2021

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventors: Akira SASAKI, Miyoshi-shi (JP); Jun HIOKI, Nagakute-shi (JP); Kazuki MATSUMOTO, Oogaki-shi (JP); Fumio WADA, Nagoya-shi (JP)

(73) Assignee: TOYOTA JIDOSHA KABUSHIKI KAISHA, Toyota-shi (JP)

(21) Appl. No.: 16/879,005

(22) Filed: May 20, 2020

(30) Foreign Application Priority Data
Jul. 31, 2019 (JP) 2019-140957

(51) Int. Cl. B60W 30/06; B60W 60/00

(52) U.S. Cl. CPC B60W 30/06; H04W 4/40; B60W 60/0023

(57) ABSTRACT

An information processing apparatus acquires images captured by a plurality of vehicles each including a camera that images a periphery of the vehicle while the vehicle is parked by wireless communication. The information processing apparatus includes a control unit. The control unit is configured to execute acquiring information on a status of each of the vehicles, selecting an imaging vehicle serving as a vehicle that performs imaging among the vehicles based on the information, generating a command to perform imaging, for the imaging vehicle, and transmitting the command to perform imaging to the imaging vehicle.

### INCORPORATION BY REFERENCE

The disclosure of Japanese Patent Application No. 2019-140957 filed on Jul. 31, 2019 including the specification, drawings and abstract is incorporated herein by reference in its entirety.

### BACKGROUND

### 1. Technical Field

The present disclosure relates to an information processing apparatus, an information processing method, and a program.

### 2. Description of Related Art

There is known a technique for preferentially guiding a vehicle to a vacant region in which monitoring accuracy by a monitoring camera or an on-vehicle camera is high (Japanese Unexamined Patent Application Publication No. 2010-277420 (JP 2010-277420 A)).

### SUMMARY

In a case where a plurality of vehicles is parked, a plurality of cameras can monitor a periphery of each of the vehicles. However, since the same place is imaged by the cameras depending on an arrangement or a direction of the vehicle, the image may be acquired more than needed. Therefore, a case may occur in which power for imaging is wasted.

The present embodiments suppress more than needed imaging from being performed by the camera included in the parked vehicle.

A first aspect of the disclosure relates to an information processing apparatus that acquires images captured by a plurality of vehicles each including a camera that images a periphery of the vehicle while the vehicle is parked by wireless communication. The information processing apparatus includes a control unit. The control unit is configured to execute acquiring information on a status of each of the vehicles, selecting an imaging vehicle serving as a vehicle that performs imaging among the vehicles based on the information, generating a command to perform imaging, for the imaging vehicle, and transmitting the command to perform imaging to the imaging vehicle.

A second aspect of the disclosure relates to an information processing method of acquiring images captured by a plurality of vehicles each including a camera that images a periphery of the vehicle while the vehicle is parked by wireless communication. In the information processing method, a computer executes acquiring information on a status of each of the vehicles, selecting an imaging vehicle serving as a vehicle that performs imaging among the vehicles based on the information, generating a command to perform imaging, for the imaging vehicle, and transmitting the command to perform imaging to the imaging vehicle.

A third aspect of the disclosure relates to a program that causes a computer to execute the information processing method, or a computer-readable storage medium non-temporarily storing the program.

According to the aspects of the disclosure, more than needed imaging is suppressed from being performed by the camera included in the parked vehicle.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram showing a schematic configuration of a monitoring system according to an embodiment;

FIG. 2 is a diagram for describing an outline of the embodiment;

FIG. 3 is a diagram for describing an outline of the embodiment;

FIG. 4 is a block diagram schematically showing an example of each configuration of a vehicle, a user terminal, and a server that configure the monitoring system according to the embodiment;

FIG. 5 is a diagram showing an example of a functional configuration of the vehicle;

FIG. 6 is a diagram showing an example of a functional configuration of the user terminal;

FIG. 7 is a diagram showing an example of a functional configuration of the server;

FIG. 8 is a diagram for describing an outline of the embodiment;

FIG. 9 is a diagram exemplifying a table configuration of vehicle information according to a first embodiment;

FIG. 10 is a diagram exemplifying a table configuration of image information;

FIG. 11 is a sequence diagram of processing of the monitoring system when the monitoring system generates a command;

FIG. 12 is a flowchart showing an example of processing of a server when the monitoring system according to the first embodiment generates a command;

FIG. 13 is a flowchart showing a flow of processing in the vehicle;

FIG. 14 is a diagram exemplifying a table configuration of vehicle information according to a second embodiment;

FIG. 15 is a flowchart showing an example of processing of the server when a monitoring system according to the second embodiment generates a command; and

FIG. 16 is a diagram for describing an outline in a case where directions of the vehicles are different.

### DETAILED DESCRIPTION OF EMBODIMENTS

An information processing apparatus according to an aspect of the disclosure acquires information on an image captured by a camera of a vehicle while the vehicle is parked. The information may be transmitted, for example, to a server or a user terminal by wireless communication. A state of “while the vehicle is parked” refers to when the vehicle is stopped and a user is not in the vehicle. The user can monitor the vehicle when the user is not in the vehicle based on the information transmitted by wireless communication.

A control unit acquires information on a status of each of a plurality of vehicles. The information on the status of each of the vehicles is information on a condition for selecting the vehicle that performs imaging, and includes a state of charge of a battery of the vehicle, an angle of view of the camera, a position of the vehicle, a direction of the vehicle, and the like. The above kind of information is information on a region to be imaged by the camera or information that can be used to determine that the vehicle cannot travel due to imaging.

In a case where the vehicles include the camera, when each of the vehicles performs imaging, a plurality of similar images may be obtained. In such a case, all of the vehicles do not need to perform imaging. That is, the power consumption of other vehicles can be reduced by selecting one vehicle among the vehicles capturing similar images and causing the vehicle to perform imaging.

After the control unit selects the vehicle that performs imaging, the control unit generates a command to cause the vehicle to perform imaging and transmits the command to the vehicle. The vehicle receiving the command performs imaging. The control unit may generate a command not to perform imaging, for the vehicle that is not selected as the vehicle that performs imaging, and may transmit the command to the vehicle.

The vehicle may be an electric vehicle. The electric vehicle needs to be parked for a certain time for charging the battery of the vehicle. In this case, even when the user moves away from the vehicle, the user can monitor the status of the vehicle with a smartphone or the like. In this case, charging of the battery can be promoted by causing only the selected vehicle to perform imaging. The vehicle may be an autonomous traveling vehicle. In a case of the autonomous traveling vehicle, the vehicle may autonomously travel based on the command generated by the control unit.

The control unit may acquire information on the state of charge of the battery included in each of the vehicles as the information on the status of each of the vehicles. As a result, since the vehicle that performs imaging can be selected according to the state of charge (SOC) of the battery, the SOC of the battery can be suppressed from being extremely reduced.

The control unit may select the vehicle with the state of charge of the battery of equal to or greater than a predetermined value as the imaging vehicle. The predetermined value here is the SOC of the battery that allows the vehicle to travel. For example, in a case where a vehicle is an electric vehicle, a predetermined distance (a destination input to a navigation system or a distance to home) may be used as the SOC that allows the vehicle to travel. In a case where the vehicle is a vehicle using an internal combustion engine as a drive source, the predetermined value may be used as the SOC needed for starting the internal combustion engine. In a case where the vehicle with the SOC smaller than the predetermined value performs imaging, the vehicle may be unable to travel due to a shortage of the SOC after imaging, and thus the vehicle is caused not to perform imaging. In this manner, the vehicle can be suppressed from being unable to travel.

The control unit may acquire information on an angle of view of the camera included in each of the vehicles, information on a position of each of the vehicles, and information on a direction of each of the vehicles as the information on the status of each of the vehicles. A region to be imaged by the camera included in each of the vehicles (hereinafter, also referred to as an imaging region) can be obtained based on the above kind of information. The vehicles of which the imaging regions overlap each other more than needed can be suppressed from being selected by selecting the vehicle that performs imaging based on the imaging region of each of the vehicles.

The control unit may select the imaging vehicle such that regions to be imaged by the cameras do not overlap each other. In this manner, the overlap region can be suppressed from being imaged. The number of imaging vehicles can be reduced, and thus the power consumption can be reduced.

The control unit may select the imaging vehicle such that regions to be imaged by the cameras overlap each other and an overlap region is smaller than a predetermined region. The predetermined region here is, for example, a region where an overlap degree of the imaging regions is out of an allowable range. The allowable range may be determined based on the overlap degree of the imaging regions for monitoring the periphery of the vehicle, or the power consumption. The control unit may set the predetermined region such that the imaging regions for monitoring the periphery of the vehicles overlap each other. The control unit may select the imaging vehicle such that the vehicles are combined in which although the imaging regions overlap each other, overlapping of the regions is minimized.

The control unit may acquire information on a direction of the camera included in each of the vehicles as the information on the status of each of the vehicles. In a case where a plurality of cameras imaging the same direction is present, similar images may be obtained. In this case, the same direction does not need to be imaged by the cameras. Therefore, imaging can be suppressed from being performed in the vehicles more than needed by selecting the imaging vehicle according to the direction of the camera. In a case where the correlation between the direction of the camera and the direction of the vehicle is known, the information on the direction of the vehicle may be acquired instead of the information on the direction of the camera.

The control unit may select the imaging vehicle such that the directions of the cameras do not overlap each other. As a result, the similar images can be suppressed from being captured.

The control unit may acquire information on an installed height of the camera included in each of the vehicles as the information on the status of each of the vehicles. In a case where the installed heights of cameras are different, the cameras have different ranges that can be imaged, and may be useful for monitoring the periphery of the vehicle. For example, when a car is compared with a bus, the camera in the bus can be installed at a higher position, and thus a more distant place can be imaged. On the other hand, the camera in the car is installed at a lower position, and thus the immediate vicinity of the vehicle can be imaged. As described above, since the characteristics of the images are different according to the installed height of the camera, a desired image can be obtained by selecting the imaging vehicle according to the installed height of the camera.

The control unit may select the imaging vehicle such that the installed heights of the cameras do not overlap each other. That is, the variations of the images can be increased by selecting the vehicle having the camera at different installed height as the imaging vehicle.

Hereinafter, embodiments of the disclosure will be described with reference to the drawings. The configuration of the following embodiment is an exemplification, and the disclosure is not limited to the configuration of the embodiment. The following embodiments can be combined as much as possible.

### First Embodiment

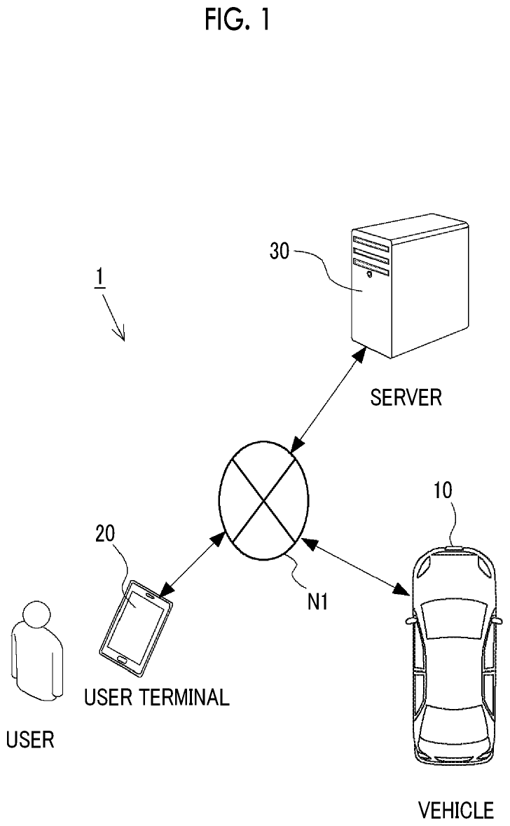

FIG. 1 is a diagram showing a schematic configuration of a monitoring system 1 according to an embodiment. The monitoring system 1 shown in FIG. 1 includes a vehicle 10, a user terminal 20, and a server 30. The monitoring system 1 is a system that causes the camera to image the periphery of the vehicle 10 and transmits the captured image to the server 30. The server 30 provides the image to the user terminal 20 in response to a request from the user terminal 20, for example. The server 30 selects the vehicle 10 that performs imaging among the vehicles 10 based on information on a status of the vehicle 10. A user in FIG. 1 is a user who operates the user terminal 20, and is, for example, a driver of the vehicle 10 or an owner of the vehicle 10.

The vehicle 10, the user terminal 20, and the server 30 are mutually connected by a network N1. The network N1 is a worldwide public communication network, such as the Internet, and a wide area network (WAN) or other communication networks may be employed as the network N1. The network N1 may include a telephone communication network, such as a mobile phone, or a wireless communication network, such as Wi-Fi (registered trademark). Although one vehicle 10 is exemplarily shown in FIG. 1, a plurality of vehicles 10 may be present. A plurality of the user terminals 20 may be present similarly to the vehicle 10. The user terminals 20 may correspond to one vehicle 10. Also, the vehicles 10 may correspond to one user terminal 20.

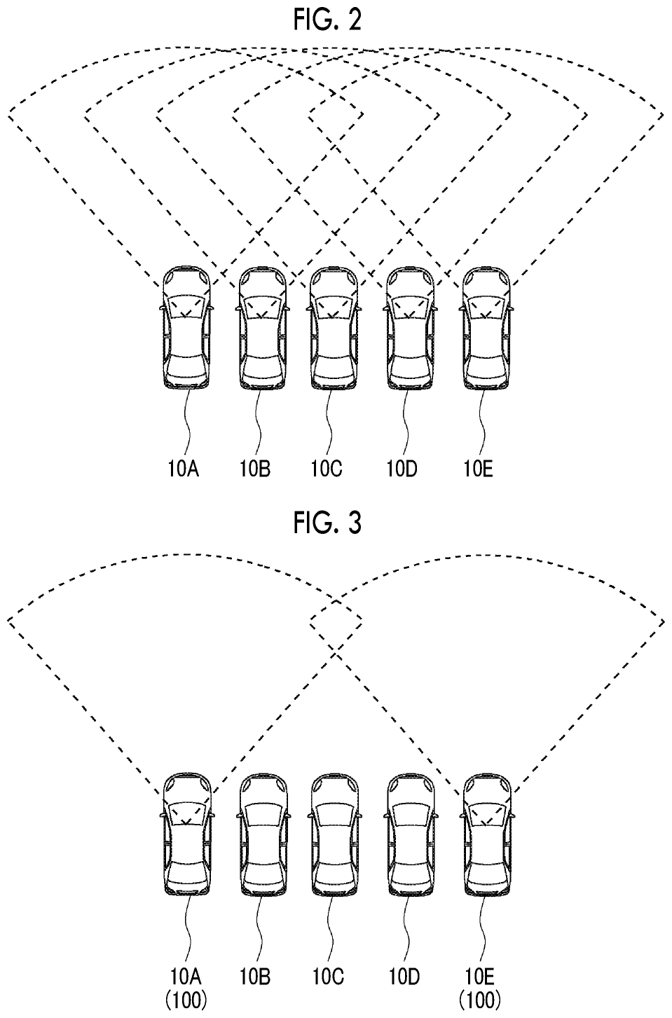

FIGS. 2 and 3 are diagrams for describing an outline of the present embodiment. FIGS. 2 and 3 exemplifies a state in which five vehicles of a first vehicle 10A, a second vehicle 10B, a third vehicle 10C, a fourth vehicle 10D, and a fifth vehicle 10E are parked side by side. In a case where these vehicles are not distinguished, the vehicles are simply referred to as the vehicle 10. In FIGS. 2 and 3, a broken line indicates a region to be imaged by the camera included in each of the vehicles 10 (the imaging region). In FIG. 2, all of the five vehicles 10 perform imaging. In this case, overlapping of the imaging regions of the vehicles 10 is large. For example, most of the imaging region of the second vehicle 10B overlaps with the imaging region of the first vehicle 10A and the imaging region of the third vehicle 10C. On the other hand, in FIG. 3, two vehicles of the first vehicle 10A and the fifth vehicle 10E perform imaging. In this case, although the regions in immediately front of the second vehicle 10B, the third vehicle 10C, and the fourth vehicle 10D cannot be imaged, overlapping of the imaging region is small and a monitorable region is sufficiently large. In the present embodiment, the vehicle 10 that performs imaging is selected such that overlapping of the imaging regions is small in a range in which the periphery of the vehicle 10 can be monitored. Hereinafter, the vehicle 10 that performs imaging is also referred to as an imaging vehicle 100.

The imaging vehicle 100 is decided based on a position of the vehicle 10, an angle of view of the camera, a direction of the vehicle 10, a direction of the camera, or the installed height of the camera (a position of the camera in a height direction). That is, the imaging region of each of the vehicles 10 changes according to the position of the vehicle 10, the angle of view of the camera, the direction of the vehicle 10, the direction of the camera, or the installed height of the camera, and thus overlapping of the imaging regions can be determined based on the above kind of information. As described above, the imaging vehicle 100 is selected based on information on the imaging region. The “information on the imaging region” is an example of the “information on a status of each of the vehicles”.

Hardware Configuration

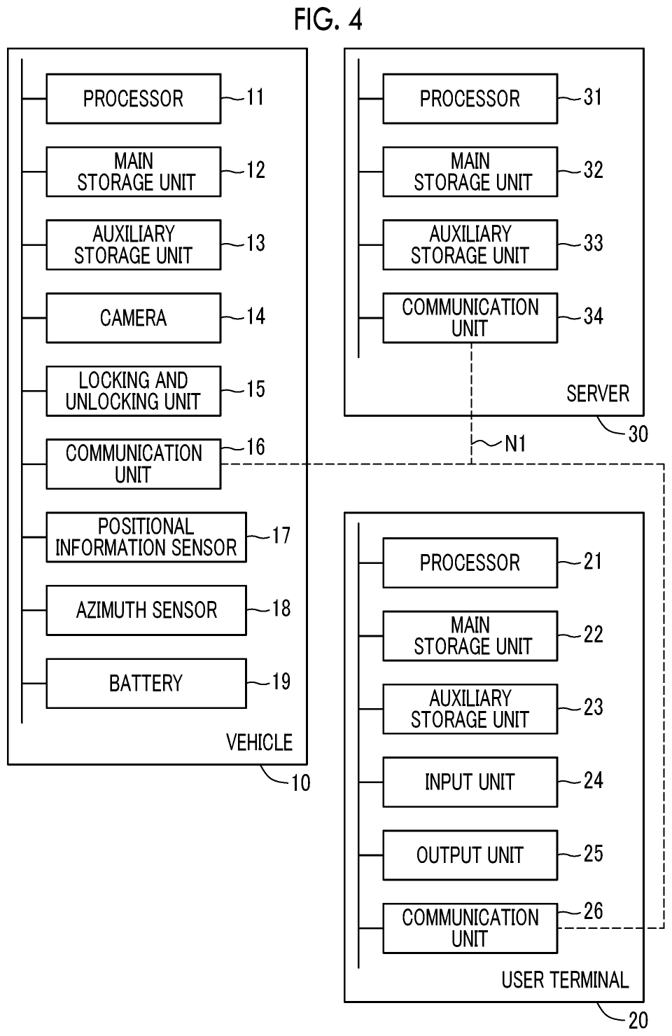

A hardware configuration of the vehicle 10, the user terminal 20, and the server 30 will be described with reference to FIG. 4. FIG. 4 is a block diagram schematically showing an example of each configuration of the vehicle 10, the user terminal 20, and the server 30 that configure the monitoring system 1 according to the present embodiment.

The vehicle 10 includes a processor 11, a main storage unit 12, an auxiliary storage unit 13, a camera 14, a locking and unlocking unit 15, a communication unit 16, a positional information sensor 17, an azimuth sensor 18, and a battery 19. These components are mutually connected by a bus. The processor 11 is a central processing unit (CPU) or a digital signal processor (DSP). The processor 11 performs the operation of various kinds of information processing for controlling the vehicle 10.

The main storage unit 12 is a random access memory (RAM) or a read only memory (ROM). The auxiliary storage unit 13 is an erasable programmable (EP) ROM, a hard disk drive (HDD), or a removable medium. The auxiliary storage unit 13 stores an operating system (OS), various programs, various tables, and the like. The processor 11 loads the program stored in the auxiliary storage unit 13 into a work area of the main storage unit 12 and executes the program, and the components are controlled through the execution of the program. The main storage unit 12 and the auxiliary storage unit 13 are computer-readable recording media. The configuration shown in FIG. 4 may be a configuration in which a plurality of computers cooperates. Information stored in the auxiliary storage unit 13 may be stored in the main storage unit 12. Also, information stored in the main storage unit 12 may be stored in the auxiliary storage unit 13.

The camera 14 performs imaging by using imaging elements, such as a charge coupled device (CCD) image sensor or a complementary metal oxide semiconductor (CMOS) image sensor. The camera 14 is installed to acquire the image of the outside of the vehicle 10 (the periphery of the vehicle 10). The image may be a still image or a moving image. The locking and unlocking unit 15 locks and unlocks doors of the vehicle 10.

The communication unit 16 is communication means for connecting the vehicle 10 to the network N1. The communication unit 16 is a circuit for performing communication with other devices (for example, a telephone communication network such as the server 30 or the user terminal 20) via the network N1 by using a mobile communication service (for example, 5th generation (5G), 4th generation (4G), 3rd generation (3G), or long term evolution (LTE)), a wireless communication network such as Wi-Fi (registered trademark).

The positional information sensor 17 acquires positional information (for example, latitude and longitude) of the vehicle 10 at a predetermined period. The positional information sensor 17 is, for example, a global positioning system (GPS) receiving unit or a wireless LAN communication unit. The information acquired by the positional information sensor 17 is recorded in, for example, the auxiliary storage unit 13 and transmitted to the server 30. The azimuth sensor 18 acquires azimuth in which the vehicle 10 faces, at a predetermined period. The azimuth sensor 18 includes, for example, a geomagnetic sensor or a gyro sensor. The information acquired by the azimuth sensor 18 is recorded in, for example, the auxiliary storage unit 13 and transmitted to the server 30. The battery 19 supplies power to the above described devices included in the vehicle 10. In a case where the vehicle 10 is an electric vehicle (EV), the battery 19 supplies power to an electric motor that drives the vehicle 10.

A series of processing executed in the vehicle 10 can be executed by hardware, and can also be executed by software. The hardware configuration of the vehicle 10 is not limited to the configuration shown in FIG. 4.

The user terminal 20 will be described. The user terminal 20 is a small computer, such as a smartphone, a mobile phone, a tablet terminal, a personal information terminal, a wearable computer (for example, a smart watch), or a personal computer (PC).

The user terminal 20 includes a processor 21, a main storage unit 22, an auxiliary storage unit 23, an input unit 24, an output unit 25, and a communication unit 26. These components are mutually connected by a bus. The processor 21, the main storage unit 22, the auxiliary storage unit 23, and the communication unit 26 included in the user terminal 20 are the same as the processor 11, the main storage unit 12, the auxiliary storage unit 13, and the communication unit 16 included in the vehicle 10, and the description will be omitted.

The input unit 24 is means for receiving an input operation of the user, and is, for example, a touch panel, a keyboard, a mouse, or a push button. The output unit 25 is means for presenting information to the user, and is, for example, a liquid crystal display (LCD), electroluminescence (EL) panel, a speaker, or a lamp. The input unit 24 and the output unit 25 may be configured as one touch panel display.

The server 30 will be described. The server 30 includes a processor 31, a main storage unit 32, an auxiliary storage unit 33, and a communication unit 34. These components are mutually connected by a bus. The processor 31, the main storage unit 32, the auxiliary storage unit 33, and the communication unit 34 included in the server 30 are the same as the processor 11, the main storage unit 12, the auxiliary storage unit 13, and the communication unit 16 included in the vehicle 10, and the description will be omitted. The processor 31 is an example of a “control unit”.

Functional Configuration: Vehicle

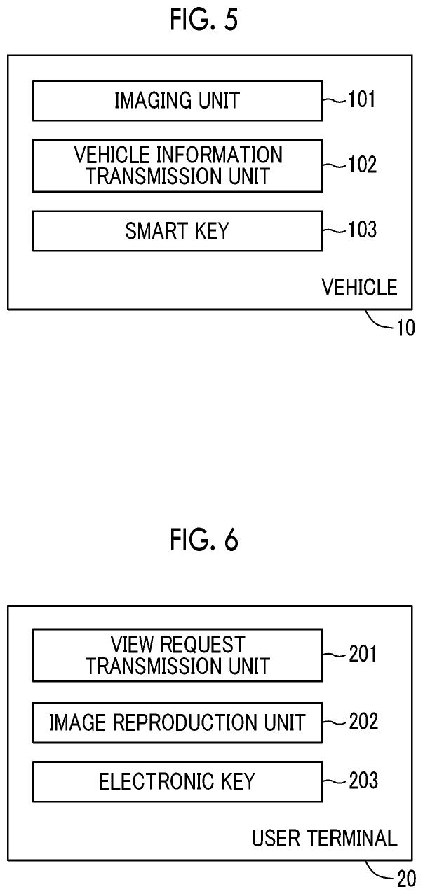

FIG. 5 is a diagram showing an example of a functional configuration of the vehicle 10. The vehicle 10 includes an imaging unit 101, a vehicle information transmission unit 102, and a smart key 103 as functional components. The imaging unit 101, the vehicle information transmission unit 102, and the smart key 103 are the functional components provided when, for example, the processor 11 of the vehicle 10 executes various programs stored in the auxiliary storage unit 13.

The imaging unit 101 acquires image information with the camera 14 and transmits the image information to the server 30 via the communication unit 16. The imaging unit 101 may acquire the image information by the camera 14 in response to a request from the server 30. The imaging unit 101 associates the image information with identification information (a vehicle ID) for identifying own vehicle and transmits the image information to the server 30.

The vehicle information transmission unit 102 transmits, for example, positional information acquired from the positional information sensor 17, azimuth information acquired from the azimuth sensor 18, information on the angle of view of the camera 14, and the status of the vehicle 10 to the server 30 via the communication unit 16. The angle of view of the camera 14 is determined by the specifications of the camera 14 and stored in, for example, the auxiliary storage unit 23. The status is information for determining whether the vehicle 10 is parked. The vehicle information transmission unit 102 determines that the vehicle 10 is parked when the vehicle 10 is stopped and the user is not in the vehicle cabin. For example, in a case where a speed of the vehicle 10 is zero, or in a case where the position of the vehicle 10 does not change, the vehicle 10 is determined to be stopped. In a case where the smart key 103 cannot communicate with an electronic key 203 owned by the user and described below, or in a case where the intensity of the radio wave from the electronic key 203 is equal to or smaller than a predetermined value, the vehicle is determined that the user is not in the vehicle cabin. Hereinafter, the positional information, the azimuth information, the information on the angle of view of the camera 14, and the status are also referred to as vehicle information. The timing at which vehicle information transmission unit 102 transmits the vehicle information can be appropriately set, for example, the vehicle information transmission unit 102 may transmit the information regularly, may transmit the information in accordance with the timing of transmitting some information to the server 30, or may transmit the information in response to the request of the server 30. The vehicle information transmission unit 102 associates the vehicle information with identification information (a vehicle ID) for identifying own vehicle and transmits the vehicle information to the server 30.

Functional Configuration: User Terminal

FIG. 6 is a diagram showing an example of a functional configuration of the user terminal 20. The user terminal 20 includes a viewing request transmission unit 201, an image reproduction unit 202, and the electronic key 203 as functional components. The viewing request transmission unit 201, the image reproduction unit 202, and the electronic key 203 are the functional components provided when, for example, the processor 21 of the user terminal 20 executes various programs stored in the auxiliary storage unit 23.

The viewing request transmission unit 201 transmits a viewing request to the server 30. The viewing request is, for example, information for requesting the user to view the image in which the periphery of the parked vehicle 10 is captured. The viewing request transmission unit 201 outputs, for example, an icon for requesting viewing of the image in which the periphery of the vehicle 10 is captured on the touch panel display of the user terminal 20, and generates the viewing request when the user clicks the icon. The viewing request transmission unit 201 associates the generated viewing request with identification information (a user ID) for identifying the user and transmits the viewing request to the server 30. The user ID is input by the user via the input unit 24 in advance and is stored in the auxiliary storage unit 23.

The image reproduction unit 202 acquires the image information transmitted from the server 30 via the communication unit 26 and displays the acquired image on the output unit 25 to make the user view the image. The electronic key 203 communicates with the smart key 103 of the vehicle 10 to lock and unlock the vehicle 10.

Functional Configuration: Server

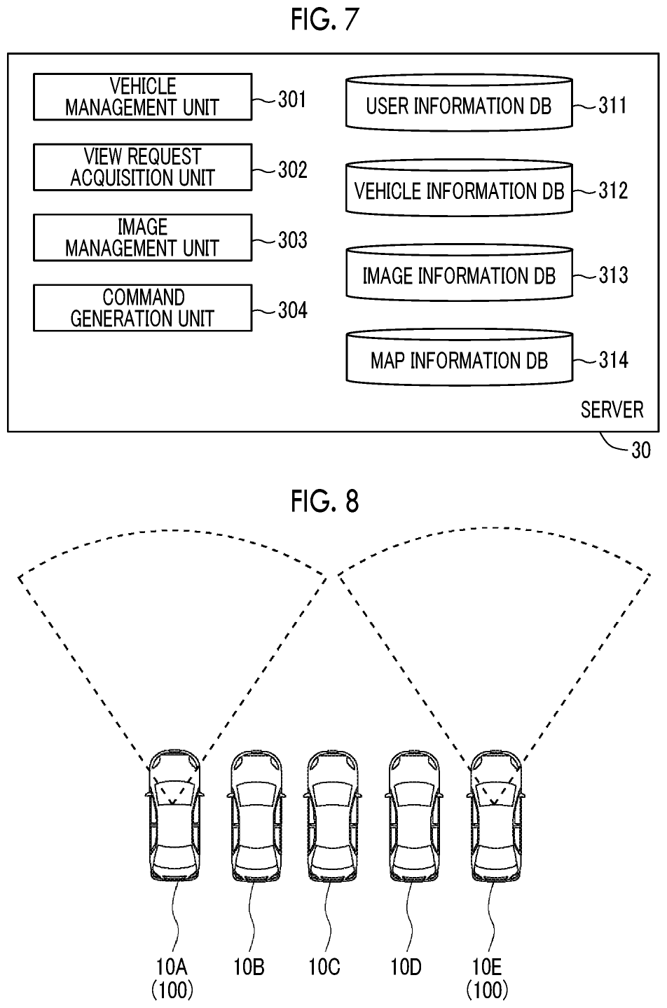

FIG. 7 is a diagram showing an example of a functional configuration of the server 30. The server 30 includes a vehicle management unit 301, a viewing request acquisition unit 302, an image management unit 303, a command generation unit 304, a user information DB 311, a vehicle information DB 312, an image information DB 313, and a map information DB 314 as functional components. The vehicle management unit 301, the viewing request acquisition unit 302, the image management unit 303, and the command generation unit 304 are the functional components provided when, for example, the processor 31 of the server 30 executes various programs stored in the auxiliary storage unit 33.

The user information DB 311, the vehicle information DB 312, the image information DB 313, and the map information DB 314 are, for example, a relational database that is constructed by managing data stored in the auxiliary storage unit 33 by a program of a database management system (DBMS) executed by the processor 31. Any of the functional components of the server 30 or a part of the processing in the functional components may be executed by another computer connected to the network N1.

The vehicle management unit 301 manages various information on the vehicle 10. The vehicle management unit 301 acquires and manages, for example, the vehicle information (the positional information, the azimuth information, the angle of view of the camera 14, and the status) transmitted from the vehicle 10. The vehicle management unit 301 associates the vehicle information with the vehicle ID and the time, and stores the vehicle information in the vehicle information DB312.

The viewing request acquisition unit 302 acquires, for example, the viewing request transmitted from the user terminal 20.

The image management unit 303 acquires and manages, for example, the image information transmitted from the vehicle 10. When the image information is acquired, the image management unit 303 associates the image information with the vehicle ID and stores the image information in the auxiliary storage unit 33. The image management unit 303 provides the image information based on the request of the user terminal 20.

The command generation unit 304 selects the imaging vehicle 100 such that the periphery of the vehicles 10 can be monitored. The command generation unit 304 selects the imaging vehicle 100 among the vehicles 10 such that the periphery of the vehicles 10 can be monitored, the imaging regions overlap each other, and overlapping of the imaging regions is minimized. The command generation unit 304 generates the command to causes the imaging vehicle 100 to perform imaging, for the imaging vehicle 100. The command generation unit 304 transmits the generated command to the imaging vehicle 100 via the communication unit 34. The command generation unit 304 may further generate the command to cause the unselected vehicle 10 not to perform imaging, for the unselected vehicle 10. The command generation unit 304 transmits the command to the unselected vehicle 10 via the communication unit 34.

For example, the command generation unit 304 selects the imaging vehicle 100 for each parking lot. The command generation unit 304 specifies the vehicle 10 stopped at the same parking lot. At this time, the command generation unit 304 compares the positional information of the vehicle 10 with the map information stored in the map information DB 314 described below, and picks out the vehicle 10 located in the same parking lot. Next, the command generation unit 304 acquires, for example, the imaging region of each of the vehicles 10. For example, the command generation unit 304 obtains the imaging region of each of the vehicles 10 based on the position and the direction of each of the vehicle 10 and the angle of view of the camera 14. The command generation unit 304 may obtain the imaging region of each of the vehicles 10 based on, for example, the image information transmitted from each of the vehicles 10. The command generation unit 304 may obtain the imaging region of each of the vehicles 10 by storing three-dimensional data of the periphery of the parking lot in the map information DB 314 and comparing the information included in the image information with the three-dimensional data of the periphery of the parking lot.

In a case where the vehicles 10 of which at least a part of the imaging regions overlap each other are present, the command generation unit 304 obtains the combination of the vehicles 10 of which overlapping of the imaging regions is minimized. For example, the command generation unit 304 sets one imaging vehicle 100, and may select the vehicle 10 of which the imaging region overlaps with the imaging region of one imaging vehicle 100 and in which overlapping is minimized, as the imaging vehicle 100, and may select the vehicle 10 of which overlapping of the imaging region with the imaging region of one imaging vehicle 100 is smaller than a predetermined region, as the imaging vehicle 100. In a word, overlapping of the imaging regions does not always need to be minimized.

On the other hand, the command generation unit 304 may select the vehicle 10 of which the imaging region is closest to the imaging region of one imaging vehicle 100 among the vehicles 10 of which the imaging region does not overlap with the imaging region of one imaging vehicle 100, as the imaging vehicle 100. In a word, the imaging regions do not need to overlap each other. FIG. 8 is a diagram for describing an outline of the embodiment. In FIG. 8, two vehicles of the first vehicle 10A and the fifth vehicle 10E perform imaging. In this case, although regions in immediately front of the second vehicle 10B, the third vehicle 10C, and the fourth vehicle 10D cannot be imaged and the imaging regions do not overlap each other, the monitorable region is sufficiently large. In the present embodiment, the vehicle 10 that performs imaging may be selected such that the imaging regions do not overlap each other in a range in which the periphery of the vehicle 10 can be monitored. As described above, the command generation unit 304 may select the imaging vehicle 100 among the vehicles 10 of which the imaging regions overlap each other, and may select the imaging vehicle 100 among the vehicles 10 of which the imaging regions do not overlap each other. A certain distance may be provided between the imaging regions of the imaging vehicles 100. The overlap degree in a case where the imaging regions overlap each other or the distance between the imaging regions in a case where the imaging regions do not overlap each other can be set depending on, for example, how much image information is requested to be acquired.

The command generation unit 304 may determine overlapping of the imaging regions by analyzing the image captured by each of the vehicles 10. For example, in a case where the same objects (the same building, the same vehicle, the same cloud, the same mountain, or the same tree) appear in the images obtained from the vehicles 10, the command generation unit 304 may determine that the imaging regions of the vehicles 10 overlap each other. The command generation unit 304 may obtain the overlap degree based on the position of the same object appearing in the image. Also, the command generation unit 304 may select the vehicle 10 that captures the image in which the same objects appear, as the imaging vehicle 100.

The command generation unit 304 generates the command to cause the imaging vehicle 100 to perform imaging by the camera 14 and transmits the image information to the server 30, and transmits the command to the imaging vehicle 100.

The user information DB 311 is formed in which the user information of the user is stored in the auxiliary storage unit 33, and each user is associated with the user information. The user information includes the user ID associated with the user, a name, an address, or the vehicle ID.

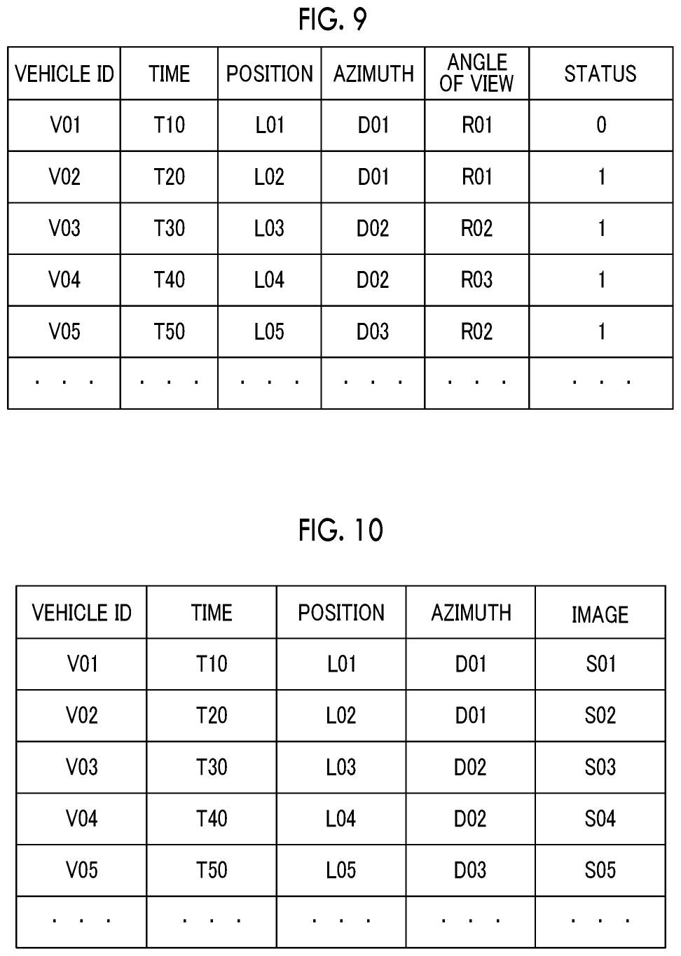

The vehicle information DB 312 is formed in which the vehicle information is stored in the auxiliary storage unit 33, and the vehicle ID is associated with the vehicle information. The configuration of the vehicle information stored in the vehicle information DB 312 will be described with reference to FIG. 9. FIG. 9 is a diagram exemplifying a table configuration of vehicle information. A vehicle information table includes fields of the vehicle ID, time, the position, the azimuth, the angle of view, and the status. Identification information for specifying the vehicle 10 is input to the vehicle ID field. Information on time at which the vehicle information is acquired is input to the time field. Positional information transmitted by the vehicle 10 is input to the position field. Azimuth information transmitted by the vehicle 10 is input to the azimuth field. The information on the angle of view of the camera 14 of the vehicle 10 is input to the field of the angle of view. The information on the status of the vehicle 10 is input to the status field. In FIG. 9, in a case where the vehicle 10 is parked, “1” is input to the status field, and in other cases, “0” is input to the status field.

The image information DB 313 is formed in which the image information is stored in the auxiliary storage unit 33, and the vehicle ID of the user is associated with the image information. The configuration of image information stored in the image information DB 313 will be described with reference to FIG. 10. FIG. 10 is a diagram exemplifying a table configuration of image information. An image information table includes fields of the vehicle ID, time, the position, the azimuth, and the image. Information (the vehicle ID) for specifying the vehicle 10 is input to the vehicle ID field. Information on time at which the image information is acquired is input to the time field. The information on the position of the vehicle 10 acquiring the image information is input to the position field. The information on the azimuth of the vehicle 10 acquiring the image information is input to the azimuth field. Information on a location where the image is stored in the auxiliary storage unit 33 is input to the image field. The image information table may include a time frame field storing a time frame (start time and end time of the moving image) in which the moving image is captured, instead of the time field.

The map information DB 314 stores the map information including point of interest (POI) information of characters or photographs indicating characteristics of each point on the map data. The map information DB 314 may be provided from other systems connected to the network N1, such as a geographic information system (GIS). The map information DB 314 includes information indicating the parking lot. Also, the map information DB 314 may include three-dimensional data of the periphery of the parking lot.

Processing Flow: Command Generation

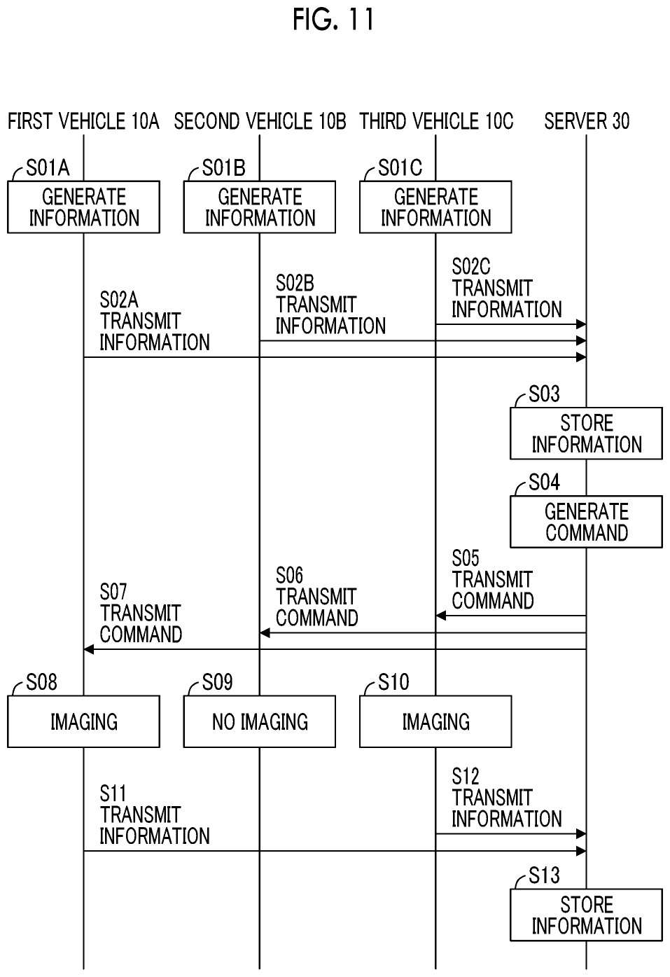

The operation when the monitoring system 1 generates the command will be described below. FIG. 11 is a sequence diagram of processing of the monitoring system 1 when the monitoring system 1 generates the command. In the sequence diagram shown in FIG. 11, a case is assumed in which three vehicles 10 (the first vehicle 10A, the second vehicle 10B, and the third vehicle 10C) are stopped in the same parking lot, a part of the imaging region of the first vehicle 10A overlaps a part of the imaging region of the second vehicle 10B, a part of the imaging region of the second vehicle 10B overlaps with a part of the imaging region of the third vehicle 10C, and imaging by the camera 14 of the second vehicle 10B is not needed.

Each of the vehicles 10 generates the vehicle information of the positional information, the azimuth information, the angle of view of the camera 14, and the status at predetermined time intervals (processing of S01A, S01B, S01C), and transmits each vehicle information to the server 30 (processing of S02A, S02B, S02C). The server 30 receiving the vehicle information associates the vehicle information with the vehicle ID and stores the vehicle information in the vehicle information DB 312 (processing of S03). The server 30 picks out the first vehicle 10A, the second vehicle 10B, and the third vehicle 10C that are parked in the same parking lot, and selects the imaging vehicle 100 such that overlapping of the imaging regions is minimized. In the sequence diagram, the first vehicle 10A and the third vehicle 10C are selected as the imaging vehicle 100, and the second vehicle 10B is not selected as the imaging vehicle 100. The server 30 generates the command for each of the vehicles 10. That is, the server 30 generates the command to perform imaging by the camera 14, for the first vehicle 10A and the third vehicle 10C, and generates the command not to perform imaging by the camera 14, for the second vehicle 10B (processing of S04). The server 30 transmits the generated command to each of the vehicles 10 (processing of S05, S06, S07). In accordance with the command, the first vehicle 10A performs imaging (processing of S08), the second vehicle 10B does not perform imaging (processing of S09), and the third vehicle 10C performs imaging (processing of S10). The first vehicle 10A and the third vehicle 10C transmit, for example, the image information to the server 30 at predetermined time intervals (processing of S11, S12). The server 30 stores information on the received image in the image information DB 313 (processing of S13).

Processing Flow: Server

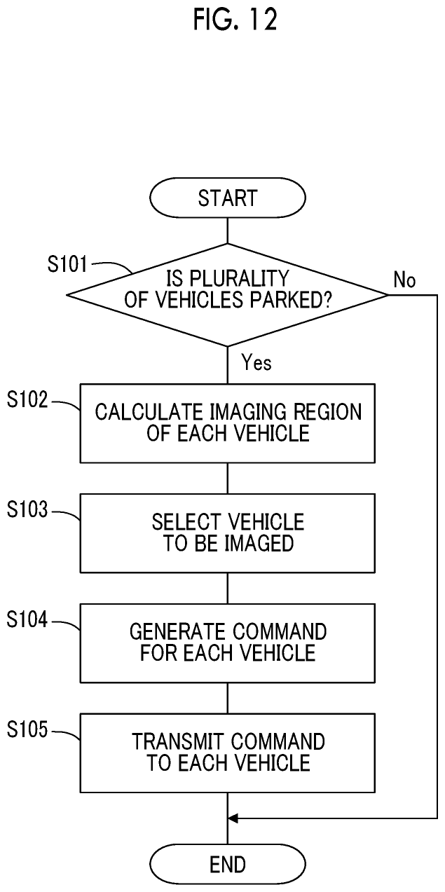

Processing of the server 30 according to the first embodiment will be described with reference to FIG. 12. FIG. 12 is a flowchart showing an example of processing of a server 30 when the monitoring system 1 according to the first embodiment generates a command. The processing of FIG. 12 is executed by the processor 31 at predetermined time intervals (for example, regular period intervals). The processing of FIG. 12 is executed for each parking lot. The server 30 is on the premise that the server 30 receives the vehicle information from each of the vehicles 10.

In step S101, the command generation unit 304 determines whether the vehicles 10 that are parked in the parking lot are present. In step S101, as the premise that the imaging regions overlap each other, a determination is made as to whether the vehicles 10 are present. The command generation unit 304 picks out the vehicle 10 parked in the same parking lot based on the positional information and the status of each of the vehicles 10. In a case where a positive determination is made in step S101, the processing proceeds to step S102, in a case where a negative determination is made in step S101, the routine is terminated. In a case where only one vehicle 10 is stopped in the parking lot, the command generation unit 304 may generate the command to cause the vehicle 10 to perform imaging, and may transmit the command to the vehicle 10.

In step S102, the command generation unit 304 calculates the imaging region of each of the vehicles 10 based on the vehicle information of each of the vehicles 10. In step S103, the command generation unit 304 selects the imaging vehicle 100 such that the imaging regions overlap each other and overlapping of the imaging regions is minimized. In step S104, the command generation unit 304 generates the command for each of the vehicles 10. The command generation unit 304 generates the command to perform imaging, for the selected vehicle 10, and generates a command not to perform imaging, for the unselected vehicle 10. In step S105, the command generation unit 304 transmits the command generated in step S104 to each of the vehicles 10.

Processing Flow: Vehicle

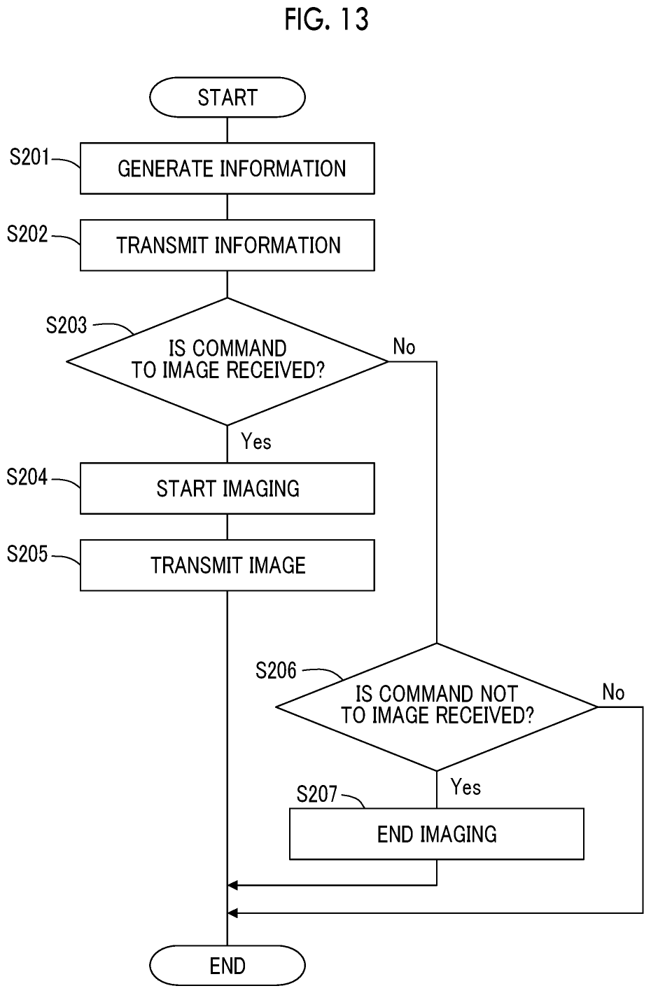

Processing in the vehicle 10 will be described with reference to FIG. 13. FIG. 13 is a flowchart showing a flow of processing in the vehicle 10. The processing of FIG. 13 is executed by the processor 11 at predetermined time intervals (for example, regular period intervals). The processing shown in FIG. 13 is executed in each of the vehicles 10.

In step S201, the vehicle information transmission unit 102 generates the vehicle information. That is, the vehicle information transmission unit 102 generates the vehicle information of the position of the vehicle 10, the direction of the vehicle 10, the angle of view of the camera 14, and the status. In step S202, the vehicle information transmission unit 102 transmits the vehicle information to the server 30. In step S203, a determination is made as to whether the imaging unit 101 receives the command to perform imaging from the server 30. In a case where a positive determination is made in step S203, the processing proceeds to step S204, in a case where a negative determination is made in step S203, the processing proceeds to step S206.

In step S204, the imaging unit 101 starts imaging with the camera 14. In a case where imaging is already started, imaging is continuously performed. In step S205, the vehicle information transmission unit 102 transmits the image information to the server 30. The image information may be transmitted at predetermined time intervals, and may be transmitted together with the vehicle information. In step S206, a determination is made as to whether the imaging unit 101 receives the command not to perform imaging from the server 30. In a case where a positive determination is made in step S206, the processing proceeds to step S207, in a case where a negative determination is made in step S206, the routine is terminated. In step S207, the imaging unit 101 terminates imaging with the camera 14. In a case where imaging is not performed, the state is maintained. In a case where imaging is terminated in step S207, the imaging unit 101 transmits the captured image to the server 30.

For example, a positive determination is made in step S203 for the vehicle 10 selected as the imaging vehicle 100, and imaging starts in step S204. In a case where the user returns to the vehicle 10 and gets on the vehicle 10, the status generated in step S201 changes, and instruction from the server 30 changes according to the changed status. That is, since the imaging unit 101 receives the command not to perform imaging from the server 30, a negative determination is made in step S203, a positive determination is made in step S206, and imaging is terminated.

For the vehicle 10 that is not selected as the imaging vehicle 100, a negative determination is made in step S203 and a positive determination is made in step S206, and imaging with the camera 14 is not performed. In a case of the traveling vehicle 10, since the status of the vehicle 10 is “0”, and the server 30 does not select the traveling vehicle 10 as the imaging vehicle 100.

The image acquired by the server 30 described above can be provided to, for example, the user. For example, when the viewing request acquisition unit 302 of the server 30 receives the viewing request transmitted from the user terminal 20, the image management unit 303 transmits, to the user terminal 20, the image information of the vehicle 10 corresponding to the user terminal 20. The vehicle 10 corresponding to the user terminal 20 is the vehicle 10 corresponding to the vehicle ID associated with the user terminal 20. In a case where the vehicle 10 corresponding to the user terminal 20 is the imaging vehicle 100, the image captured by the imaging vehicle 100 is transmitted to the user terminal 20. In a case where the vehicle 10 corresponding to the user terminal 20 is not the imaging vehicle 100, for example, the image captured by the imaging vehicle 100 present closest to the vehicle 10 is transmitted to the user terminal 20. The user may select and view the image captured by each imaging vehicle 100 in the parking lot.

As described above, according to the present embodiment, in a case where the vehicles 10 are stopped in the same parking lot, the image for monitoring the parking lot can be captured by a minimum number of the vehicles 10. As a result, the power consumption in the entire of the monitoring system 1 can be reduced. In a case where the battery 19 is charged while the vehicle 10 is parked, the vehicle 10 other than the imaging vehicle 100 can be quickly charged. The image information can be suppressed from being transmitted to the server more than needed, and thus the storage capacity of the server 30 can be reduced or the traffic volume can be reduced.

### Second Embodiment

In the first embodiment, the server 30 selects the imaging vehicle 100 based on the information on the imaging region of each of the vehicles 10. On the other hand, in the second embodiment, the server 30 selects the imaging vehicle 100 based on the state of charge (SOC) of the battery 19 of each of the vehicles 10. In a case where the vehicle 10 with the small SOC performs imaging, the vehicle 10 may be hard to travel. For example, in a case where the vehicle 10 is an electric vehicle, when imaging is performed with the small SOC, power needed for traveling may not be able to be obtained from the battery 19. In a case where the vehicle 10 is driven by the internal combustion engine, when imaging is performed with the small SOC, power needed for starting the internal combustion engine may not be able to be obtained from the battery 19. Therefore, in the second embodiment, the vehicle 10 with a relatively large SOC is selected as the imaging vehicle 100. The “information on the SOC of the battery 19” is an example of “information on a status of each of the vehicles”.

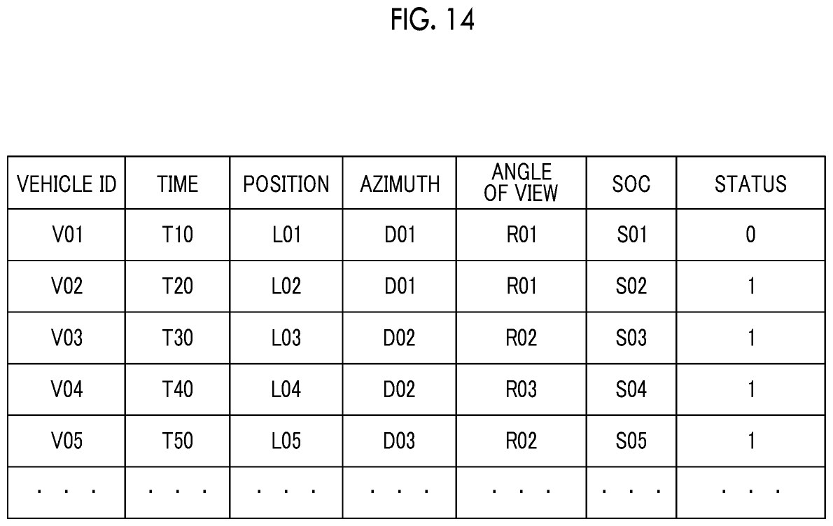

For example, the vehicle information generated by the vehicle information transmission unit 102 of the vehicle 10 includes the information on the SOC of the battery 19. That is, the vehicle information transmission unit 102 of the vehicle 10 generates the information on the SOC of the battery 19 and transmits the information to the server 30. The vehicle information transmission unit 102 generates the information on the SOC of the battery 19 using a known technique. In a case where the information on the SOC of the battery 19 is received from the vehicle information transmission unit 102, the vehicle management unit 301 of the server 30 stores the information in the vehicle information DB 312. FIG. 14 is a diagram exemplifying a table configuration of vehicle information according to a second embodiment. The vehicle information table includes fields of the vehicle ID, time, the position, the azimuth, the angle of view, the SOC, and the status. The information on the SOC of the battery 19 of the vehicle 10 is input to the SOC field. Other fields are the same as in FIG. 9.

For example, the command generation unit 304 of the server 30 determines whether the SOC of the battery 19 of the vehicle 10 is equal to or greater than the predetermined value as a condition for selecting the imaging vehicle 100. The vehicle 10 with the SOC equal to or greater than the predetermined value is selected, and the vehicle 10 with the SOC smaller than the predetermined value is not selected. The predetermined value here is the SOC that allows the vehicle 10 to travel. For example, in a case where the vehicle 10 is an electric vehicle, a predetermined distance (a destination input to a navigation system or a distance to home) is used as the SOC that allows the vehicle to travel. In a case where the vehicle 10 is a vehicle using an internal combustion engine as a drive source, the predetermined value is used as the SOC needed for starting the internal combustion engine. In a case where the SOC is smaller than the predetermined value, the vehicle 10 may be unable to travel due to imaging, and thus the vehicle is caused not to perform imaging. In a case where the vehicles 10 of which the imaging regions overlap each other are present, the vehicle 10 may be selected in descending order of the SOC.

Processing Flow: Server

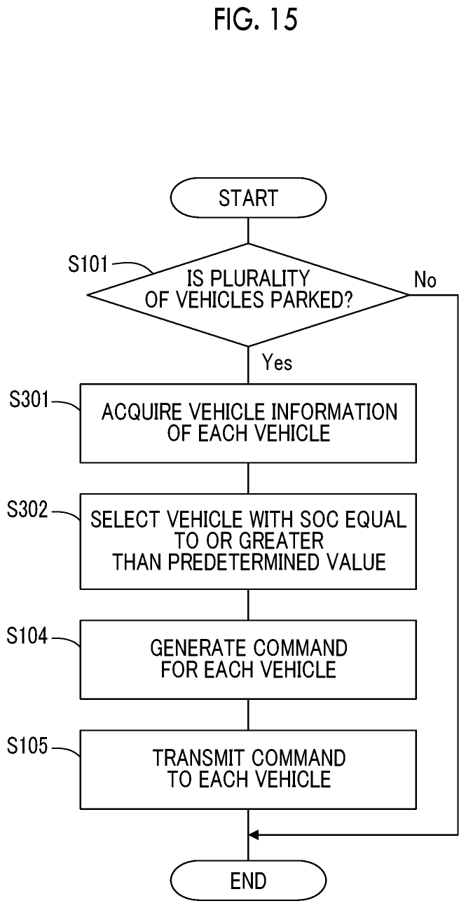

Processing of the server 30 according to the second embodiment will be described with reference to FIG. 15. FIG. 15 is a flowchart showing an example of processing of the server 30 when a monitoring system 1 according to the second embodiment generates a command. The processing of FIG. 15 is executed by the processor 31 at predetermined time intervals (for example, regular period intervals). The processing of FIG. 15 is executed for each parking lot. The server 30 is on the premise that the server 30 receives the vehicle information from each of the vehicles 10. Steps in which the same processing as the processing shown in FIG. 12 is performed are denoted by the same reference numerals and the description is omitted.

In the flowchart shown in FIG. 15, in a case where a positive determination is made in step S101, the processing proceeds to step S301. In step S301, the command generation unit 304 acquires the vehicle information including the SOC of the battery 19 for each of the parked vehicles 10 from the vehicle information DB 312. In step S302, the command generation unit 304 selects the vehicle 10 such that the vehicle 10 with the SOC equal to or greater than the predetermined value is the imaging vehicle 100. Thereafter, processing proceeds to step S104.

In a case where any one of two vehicles 10 of which the imaging regions overlap with each other is selected, the vehicle 10 with the large SOC may be selected. At this time, only the vehicle 10 with the SOC equal to or greater than the predetermined value may be selected. Even in a case where the imaging regions overlap each other, a predetermined number of vehicles 10 among the vehicles 10 may be selected in descending order of the SOC to be the imaging vehicle 100. At this time, only the vehicle 10 with the SOC equal to or greater than the predetermined value may be selected. The predetermined number of vehicles is the number of vehicles 10 that can sufficiently monitor in the parking lot. In a word, the predetermined number of vehicles may be set according to the scale of the parking lot.

As described above, according to the present embodiment, since the vehicle 10 that is not able to travel due to imaging is not selected as the imaging vehicle 100, the vehicle 10 after parking is suppressed from being unable to travel. Since the vehicle 10 with the small SOC does not perform imaging, charging of the battery 19 can be promoted in the parking lot.

### Third Embodiment

In the third embodiment, a timing at which the vehicle 10 is to be a selection target as the imaging vehicle 100, and a timing at which the vehicle 10 is not to be the selection target as the imaging vehicle 100 will be described. In the third embodiment, the server 30 selects the imaging vehicle 100 among the vehicles 10 that are the selection target as the imaging vehicle 100, as described in the above embodiment. In the third embodiment, in a case where the vehicle 10 is selected as the imaging vehicle 100, when the imaging vehicle 100 receives the command from the server 30, the imaging vehicle 100 starts imaging. On the other hand, in a case where the vehicle 10 is not selected as the imaging vehicle 100, when the command is received from the server 30, the imaging vehicle 100 terminates imaging.

In the first embodiment, for example, in a case where the user gets off the vehicle 10, the vehicle 10 is determined to be parked and is to be the selection target. In the second embodiment, for example, the vehicle 10 of which the SOC of the battery 19 is equal to or greater than the predetermined value is the selection target. In the first embodiment, for example, in a case where the user gets on the vehicle 10, the vehicle 10 is determined not to be parked and is excluded from the selection target. In the second embodiment, for example, the vehicle 10 of which the SOC of the battery 19 is smaller than the predetermined value is excluded from the selection target. In the present embodiment, a determination is made as to whether the vehicle 10 is to be the selection target as the imaging vehicle 100, based on the condition different from the above embodiment. Hereinafter, the description will be made on the premise that the vehicle 10 is an electric vehicle and the battery 19 can be charged in the parking lot while the vehicle 10 is parked.

In the present embodiment, for example, the vehicle 10 of which a distance to the user is equal to or greater than a predetermined distance may be the selection target, and the vehicle 10 of which a distance to the user is smaller than the predetermined distance may be excluded from the selection target. The predetermined distance may be a distance at which the user needs to monitor the user's vehicle 10. That is, even when the user gets off the vehicle 10, when the user is near the vehicle 10, the user can directly monitor the periphery of the vehicle 10, and thus the periphery of the vehicle 10 does not need to be imaged. For example, in a case where the user approaches the vehicle 10 and the distance from the vehicle 10 to the user is smaller than the predetermined distance, the user is considered to move the vehicle 10. In this case, the vehicle 10 is excluded from the selection target, and the other vehicles 10 may be selected as the imaging vehicle 100. As a result, before own vehicle starts to move, imaging by the other vehicles 10 is started, and the image for monitoring can be captured without interruption. The distance from the vehicle 10 to the user can be calculated based on the radio wave intensity in communication between the smart key 103 and the electronic key 203. The distance at which the smart key 103 can communicate with the electronic key 203 may be the predetermined distance. Also, the distance at which the smart key 103 is locked or unlocked by the electronic key 203 may be the predetermined distance.

When the command generation unit 304 of the server 30 selects the imaging vehicle 100 in step S103 in FIG. 12, the imaging vehicle 100 is selected among the vehicles 10 that are the selection target.

As described above, according to the present embodiment, the condition for selecting the vehicle 10 as the imaging vehicle 100 can be set to the different conditions from the other embodiments. Therefore, a variation can be given to the method of selecting the imaging vehicle 100.

Other Embodiments

The above embodiments are merely an example, and the present embodiments can be implemented with appropriate modifications within a range not departing from the gist of the disclosure. In the above embodiment, the server 30 includes the vehicle management unit 301, the viewing request acquisition unit 302, the image management unit 303, and the command generation unit 304, a part or all of these functional components may be included in the vehicle 10 or the user terminal 20.

Also, for example, the vehicle information may be input to the user terminal 20 by the user, and may be transmitted to the server 30 from the user terminal 20.

For example, at least a part of the control unit of the embodiment may be the processor 11 of the vehicle 10 or the processor 21 of the user terminal 20.

In the above embodiments, although the user drives the vehicle 10, the vehicle 10 may be an autonomous traveling vehicle. In this case, the server 30 may generate a driving command for the vehicle 10. The server 30 may transmit the driving command to the vehicle 10, and the vehicle 10 that receives the driving command may autonomously travel.

In the above embodiments, although monitoring in the parking lot is described, the embodiment can also be applied to a case where monitoring is performed other places where vehicles 10 can be stopped (for example, a ferry that carries the vehicle 10, a train that carries the vehicle 10, and a vehicle that carries the vehicle 10).

The command generation unit 304 may select based on the direction of the camera 14 of each of the vehicles 10 when selection of the imaging vehicle 100 is performed. In this case, the imaging vehicle 100 may be selected based on the direction of each of the vehicles 10 assuming that the direction of the camera 14 is the same as the direction of the vehicle 10. The “information on the direction of the camera 14” or the “information on the direction of the vehicle 10” is an example of “information on a status of each of the vehicles”. For example, any one of the vehicles 10 that face the same direction in the parking lot may be selected as the imaging vehicle 100. The vehicle 10 with the largest SOC of the battery 19 among the vehicles 10 that face the same direction may be selected as the imaging vehicle 100. Similar images may be acquired from the cameras 14 facing the same direction. For example, in a case of a relatively small parking lot, the camera 14 of the one vehicle 10 may be able to image most regions of the parking lot. In such a case, when one vehicle 10 is selected, the image sufficient for monitoring can be acquired. For example, in step S103 of the flowchart shown in FIG. 12, any one imaging vehicle 100 among the vehicles 10 facing the same direction may be selected.

In the above embodiments, although the imaging vehicle 100 is selected based on the angle of view of the camera 14, in a case where the installed heights of the cameras 14 are different even when the angles of view of the cameras 14 are the same, the appearance of the image may be different, or the captured object in the image may be different. Therefore, the vehicle 10 may be selected according to the installed height of the camera 14. The “information on the installed height of the camera 14” is an example of “information on a status of each of the vehicles”. For example, even in a case where the vehicles 10 have the imaging regions overlapping each other, when the installed height of the camera 14 is different in each of the vehicles 10, any of the vehicles 10 may be selected as the imaging vehicle 100. That is, the imaging vehicle 100 may be selected such that the positions of the cameras 14 in the height direction do not overlap each other. For example, the installed heights of the cameras 14 may be classified into three types of high, medium, and low, and the vehicles 10 corresponding to heights of different types may be selected. For example, in step S103 of the flowchart shown in FIG. 12, the imaging vehicle 100 may be selected such that the positions of the cameras 14 in the height direction do not overlap each other.

In a case where the imaging regions of the first vehicle 10A and the second vehicle 10B overlap with each other, when the second vehicle 10B starts imaging, the first vehicle 10A may terminate imaging. In this case, the user of the first vehicle 10A may select whether to terminate imaging by the first vehicle 10A. In a case where the imaging regions of the first vehicle 10A and the second vehicle 10B overlap with each other, when the second vehicle 10B terminates imaging, the first vehicle 10A may start imaging. In this case, the user of the first vehicle 10A may select whether to start imaging by the first vehicle 10A. In this manner, the first vehicle 10A can be caused not to perform imaging when the second vehicle 10B performs imaging, and thus charging of the battery 19 of the first vehicle 10A can be promoted. Also, the first vehicle 10A performs imaging when the second vehicle 10B does not perform imaging, and thus more reliable monitoring can be performed and charging of the battery 19 of the second vehicle 10B can be promoted.

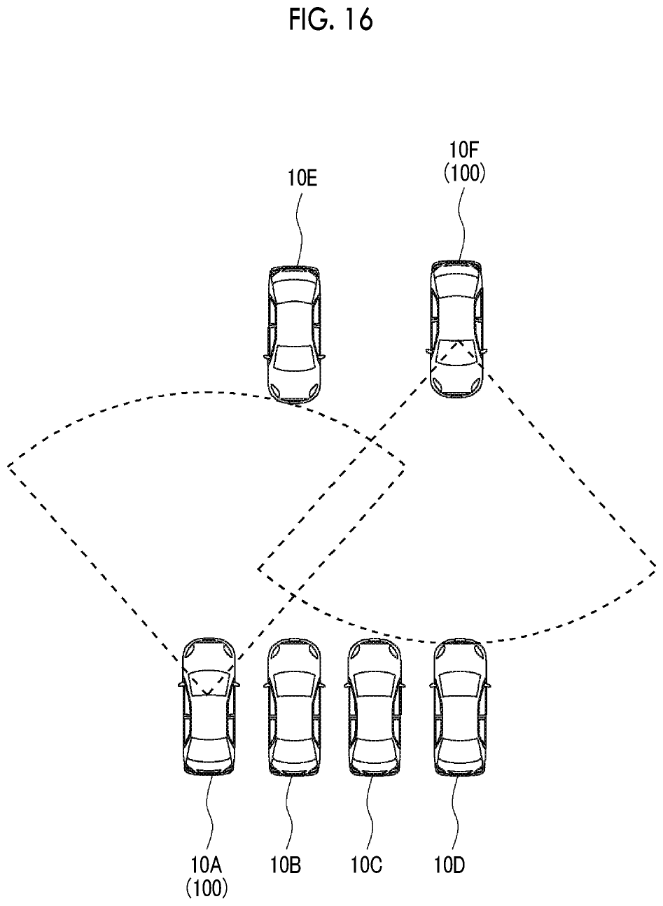

Even in a case where the directions of the vehicles 10 are different, the imaging vehicle 100 can be selected such that the overlap range of the imaging regions is minimized. FIG. 16 is a diagram for describing an outline in a case where directions of the vehicles 10 are different. In FIG. 16, the first vehicle 10A, the second vehicle 10B, the third vehicle 10C, and the fourth vehicle 10D are arranged side by side, and the fifth vehicle 10E and the sixth vehicle 10F are arranged to face the direction different from the first vehicle 10A. As shown in FIG. 16, when two of the first vehicle 10A and the sixth vehicle 10F perform imaging, the image in a range closes to a case where all of the vehicles 10 perform imaging can be obtained. Even in a case where the directions of the vehicles 10 are different, the imaging vehicle 100 can be selected such that the imaging regions do not overlap each other.

The processing and means described in the present disclosure can be freely combined and implemented as long as no technical inconsistency occurs.

The processing performed by one device in the description may be executed by a plurality of devices. Alternatively, the processing performed by different devices in the description may be executed by one device. In the computer system, the hardware configuration (the server configuration) that realizes each function can be flexibly changed.

The present embodiments can also be realized by supplying a computer program that implements the functions described in the above embodiments to a computer, and reading and executing the program by one or more processors included in the computer. Such a computer program may be provided to the computer by a non-transitory computer-readable storage medium connectable to a system bus of the computer, or may be provided to the computer via a network. The non-transitory computer-readable storage medium includes, for example, any type of disk, such as a magnetic disk (floppy (registered trademark) disk or hard disk drive (HDD)), an optical disk (CD-ROM, DVD disk, or Blu-ray disk), read only memory (ROM), random access memory (RAM), EPROM, EEPROM, magnetic card, flash memory, optical card, and any type of media suitable for storing electronic instructions.

What is claimed is:

1. An information processing apparatus that acquires images captured by a plurality of vehicles each including a camera that images a periphery of the vehicle while the vehicle is parked by wireless communication, the apparatus comprising a control unit configured to execute
acquiring information on a status of each of the vehicles,
selecting an imaging vehicle serving as a vehicle that performs imaging among the vehicles based on the information,
generating a command to perform imaging, for the imaging vehicle, and
transmitting the command to perform imaging to the imaging vehicle.

2. The information processing apparatus according to claim 1, wherein the control unit is configured to acquire information on a state of charge of a battery included in each of the vehicles as the information on the status of each of the vehicles.

3. The information processing apparatus according to claim 2, wherein the control unit is configured to select a vehicle with the state of charge of the battery of equal to or greater than a predetermined value as the imaging vehicle.

4. The information processing apparatus according to claim 1, wherein the control unit is configured to acquire information on an angle of view of the camera included in each of the vehicles, information on a position of each of the vehicles, and information on a direction of each of the vehicles as the information on the status of each of the vehicles.

5. The information processing apparatus according to claim 4, wherein the control unit is configured to select the imaging vehicle such that regions to be imaged by the cameras do not overlap each other.

6. The information processing apparatus according to claim 4, wherein the control unit is configured to select the imaging vehicle such that regions to be imaged by the cameras overlap each other and an overlap region is smaller than a predetermined region.

7. The information processing apparatus according to claim 1, wherein the control unit is configured to acquire information on a direction of the camera included in each of the vehicles as the information on the status of each of the vehicles.

8. The information processing apparatus according to claim 7, wherein the control unit is configured to select the imaging vehicle such that the directions of the cameras do not overlap each other.

9. The information processing apparatus according to claim 1, wherein the control unit is configured to acquire information on an installed height of the camera included in each of the vehicles as the information on the status of each of the vehicles.

10. The information processing apparatus according to claim 9, wherein the control unit is configured to select the imaging vehicle such that the installed heights of the cameras do not overlap each other.

11. An information processing method of acquiring images captured by a plurality of vehicles each including a camera that images a periphery of the vehicle while the vehicle is parked by wireless communication, the method comprising:
by a computer,
acquiring information on a status of each of the vehicles;
selecting an imaging vehicle serving as a vehicle that performs imaging among the vehicles based on the information;
generating a command to perform imaging for the imaging vehicle; and
transmitting the command to perform imaging to the imaging vehicle.

12. A program that causes a computer to execute an information processing method of acquiring images captured by a plurality of vehicles each including a camera that images a periphery of the vehicle while the vehicle is parked by wireless communication, the program causing the computer to execute
acquiring information on a status of each of the vehicles;
selecting an imaging vehicle serving as a vehicle that performs imaging among the vehicles based on the information;
generating a command to perform imaging for the imaging vehicle; and
transmitting the command to perform imaging to the imaging vehicle.
